(19) United States
(12) Patent Application Publication
(10) Pub. No.: US 2005/0163296 A1
(43) Pub. Date: Jul. 28, 2005

(54) Collect callback for web-based access

(75) Inventors: Jeffrey B. Smith, Veradale, WA (US); Michael L. Eberle, Vista, CA (US)

Correspondence Address: LEE & HAYES, PLLC, 421 W. RIVERSIDE AVE, STE 500, SPOKANE, WA, 99201, US

(73) Assignee: dX/dY Voice Processing, Inc., Spokane, WA (US)

(21) Appl. No.: 11/087,210

(22) Filed: Mar. 23, 2005

Related U.S. Application Data
(63) Continuation-in-part of application No. 10/672,348, filed on Sep. 26, 2003.

(51) Int. Cl. H04M 15/00; H04M 3/42

(52) U.S. Cl. 379/114.2; 379/210.01

(57) ABSTRACT

Collect callback for Web-based access is described. In an embodiment, a Web-based resource provides a collect callback option via which a call source can obtain an access code to access the Web-based resource. A switch receives callback data from the Web-based resources and utilizes the callback data to establish a collect call via a telephone-based communication link between the call source and an access code provider that provides the access code to the call source. In an alternate embodiment, the switch establishes the collect call between the call source and the switch which provides the access code to the call source.

### RELATED APPLICATION

This application is a continuation-in-part and claims priority to U.S. patent application Ser. No. 10/672,348 entitled “Collect Callback” filed Sep. 26, 2003 to Smith et al., the disclosure of which is incorporated by reference herein.

This application is also related to a concurrently-filed U.S. patent application Ser. No. __/___,___ (Attorney Docket No. XY1-002US) entitled “Collect Callback” to Smith et al., the disclosure of which is incorporated by reference herein.

### TECHNICAL FIELD

This invention relates to collect callback.

### BACKGROUND

Some telephone switching systems provide a callback feature that allows a caller to call the switching system, receive a hang-up response tone or some other indication from the system, and have the switching system call back so that the caller can dial a long distance number, yet maintain a cheaper rate through the switching system. Another caller-initiated callback system enables a caller to submit a callback request via the Internet, such as to a call center, and directly from an HTML page. The call center then completes the call to the number provided by the caller. These and other conventional caller-initiated callback systems are convenient and economical for business travelers and vacationers, for example, that travel overseas yet do not want to pay for the high costs, or tariffs, to place a call through a foreign telecommunications system.

Some Web sites (e.g., the World Wide Web) require a customer or computer user to pay a fee to gain access to a Web site, such as an ISP (Internet Service Provider), or to a Web site that solicits customers to provide an information service, technical support service, a buying club membership, and for other paid access services. This access to a Web site can typically be paid for by a customer with a credit card (e.g., Visa, Master Card, or American Express), or by mailing in a check to pay for the access. Some potential customers, such as computer users, may not have access to a credit card or bank check to pay for Web site access and/or may not want to wait for a check to be delivered and processed via the mail system. These potential customers, as well as the providers of paid-for Web services, would benefit from an alternate payment system via which a computer user can pay for access to a Web site and/or Internet-based services.

### SUMMARY

Collect callback for Web-based access is described herein.

In an implementation, a Web-based resource provides a collect callback option via which a call source can obtain an access code to access the Web-based resource. A switch receives callback data from the Web-based resource and utilizes the callback data to establish a collect call via a telephone-based communication link between the call source and an access code provider that provides the access code to the call source. In an alternate embodiment, the switch establishes the collect call between the call source and the switch which provides the access code to the call source.

### BRIEF DESCRIPTION OF THE DRAWINGS

The same numbers are used throughout the drawings to reference like features and components.

FIG. 1 illustrates an exemplary collect callback system in which collect callback for Web-based access can be implemented.

FIG. 2 illustrates another exemplary collect callback system in which collect callback for Web-based access can be implemented.

FIG. 3 illustrates examples of data associated with collect callback for Web-based access which is maintained with a database as shown in FIG. 2.

FIG. 4 illustrates examples of recorded and associated data maintained with an archive as shown in FIG. 2.

FIG. 5 illustrates an exemplary collect callback system having any number of various components in which collect callback for Web-based access can be implemented.

FIG. 6 illustrates an exemplary implementation of collect callback for Web-based access.

FIG. 7 further illustrates the exemplary implementation of collect callback for Web-based access shown in FIG. 6.

FIGS. 8A and 8B illustrate a flow diagram of an exemplary method for collect callback for Web-based access.

FIG. 9 illustrates various components of an exemplary computing device that may be implemented as various components of a collect callback system in which collect callback for Web-based access can be implemented.

### DETAILED DESCRIPTION

Collect callback for Web-based access is described in which a Web-based resource provides a collect callback option for a call source, such as for a computer user or customer wanting to access the Web-based resource via an Internet communication link. In one embodiment, the Web-based resource can be accessed with an access code entered at a Web site that is associated with the Web-based resource. In an event that a customer accepts the collect callback option, the Web-based resource communicates callback data to a switch that utilizes the callback data to authorize a collect call for the customer and to establish the collect call via a telephone-based communication link between the customer (e.g., computer user) and an access code provider.

The access code provider can be a live person, an automated device, or any other type of telecommunication device that provides the access code to the customer which can then utilize the access code to gain access to the Web-based resource. The collect call can be established via the telephone-based communication link through the switch, and acceptance of the collect call by a call source establishes that the computer user at the call source can be charged on the call source's phone bill for the Web-based resource access code and/or for on-line access time.

Collect callback for Web-based access may be implemented as part of a telecommunications system, a public switched telephone network, or as component(s) of any other communication and/or information services system, such as Web-based resource via the Internet. While aspects of the described systems and methods for collect callback for Web-based access can be implemented in any of these systems, collect callback for Web-based access is described in the context of the following exemplary environment(s).

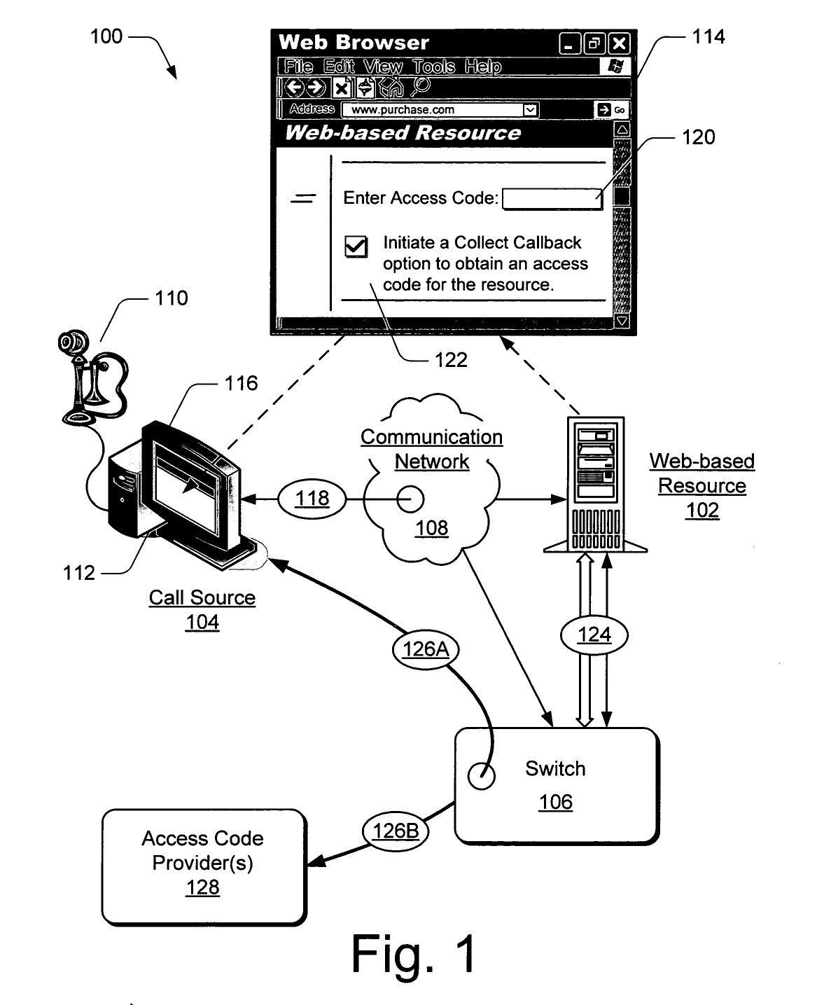

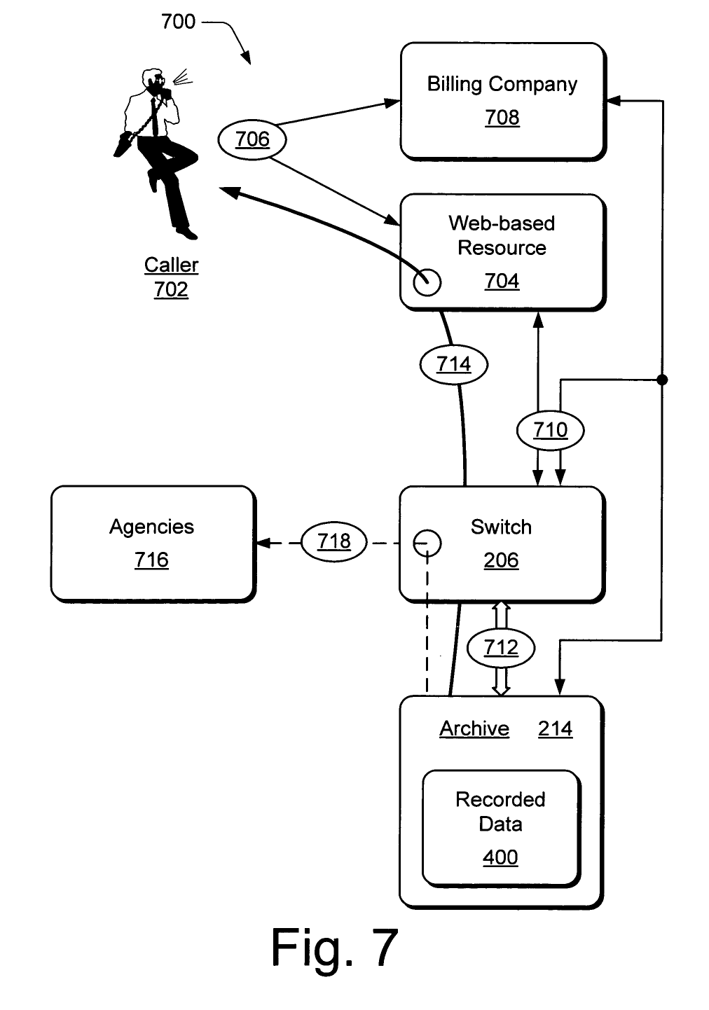

FIG. 1 illustrates an exemplary collect callback system 100 in which an embodiment of collect callback for Web-based access can be implemented. The collect callback system 100 includes a Web-based resource 102, a call source 104, and a switch 106, each of which are configured for communication via a communication network 108, such as an intranet or the Internet. The collect callback system 100 can be implemented in any form of telecommunications, communications, and/or information services system to include an Internet-based communication system. Web-based resource 102 may be implemented as any number of different server and/or computing devices that provide access to any type of resources and/or data for a fee, such as an information service, technical support service, research database service, membership buying club, and the like. In one implementation of collect callback for Web-based access, a collect callback system can be implemented as an on-line dating service which is described with reference to FIG. 6.

Although the Web-based resource 102 and the switch 106 are each illustrated and described as independent components of the collect callback system 100, the Web-based resource 102 can be implemented as an integrated component of the switch 106, and vice-versa. Accordingly, any functionality described herein pertaining to an automated or Web-based resource and/or pertaining to a switch can be performed by either one or both of the Web-based resource and the switch as described with reference to the various embodiments of collect callback for Web-based access.

In the example shown in FIG. 1, call source 104 may be a person (e.g., a computer user), a communication device 110 (e.g., a telephone, either wired or wireless), an automated device, any other type of electronic or computing device 112 to facilitate Web-based access, and/or any combination thereof at a call origin, call station, call location, etc. Although the telephone 110 is illustrated as being communicatively coupled through computing device 112, the telephone 110 may be configured for communication independent of computing device 112. In this example, computing device 112 includes a Web browser application to facilitate user interaction with a Web site 114 that is associated with the Web-based resource 102 and which can be displayed on display device 116 of computing device 112.

When a computer user at call source 104 initiates communication with Web-based resource 102, a communication link 118 is established such that the Web-based resource 102 and the call source 104 are communicatively coupled, or connected, either via a wired or wireless connection over communication network 108. A computer user at call source 104 may be enticed to access the Web-based resource 102 via the associated Web site 114 for a duration during which the computer user may or may not be charged for the Web site access (e.g., via communication link 118). The Web-based resource 102 may then offer the computer user at call source 104 a number of payment options to continue the on-line access, such as charging the Web-based resource access time to a credit card, calling a nine-hundred number to which a billing rate applies to receive an access code 120 (e.g., such as a flat fee), or the Web-based resource 102 can initiate a collect callback option 122 via the associated Web site 114 for the computer user at call source 104.

In an event that a computer user at call source 104 selects the collect callback option (e.g., the computer user authorizes a collect call as a form of payment to continue or to gain access to the Web-based resource 102), the Web-based resource 102 communicates callback data to the switch 106 via any type of communication link 124. The computer user at call source 104 can initiate the collect callback option 122 via the associated Web site 114 by initiating a selectable control option on the Web browser user interface.

The Web-based resource 102 and switch 106 may each include a communication interface by which the components are communicatively linked. The communication link(s) 108, 118, and 124, and the other communication links described herein with reference to the several collect callback system implementations of collect callback for Web-based access, can be any one or combination of a serial, parallel, network, wireless, satellite, Internet, or public switched telephone network interface that communicatively couples the components with each other and/or with other electronic or computing devices. Other examples of a communication link implementation can include digital, universal serial bus (USB), local area network (LAN), wide area network (WAN), metropolitan area network (MAN), any form of an Internet Protocol (IP) connection, and other similar types of information and communication connections.

The callback data communicated from Web-based resource 102 to switch 106 includes a Web-based resource identifier (e.g., any type of number and/or text designator) and a call source identifier (e.g., a ten-digit telephone number corresponding to the call source 104). The switch 106 utilizes the call source identifier to initiate and establish a collect call via a telephone-based communication link 126(A-B) between the call source 104 (e.g., the computer user at telephone 110) and an access code provider 128 that provides the access code 120 to the computer user. In this example, the collect call communication link 126(A-B) is routed through the switch 106, and acceptance of the collect call by the call source establishes that the computer user at call source 104 can be charged on the call source's phone bill for the Web-based resource access code 120 and/or for the on-line access time. A telephone-based communication link (e.g., communication link 126) can be implemented with any type of telephone communication protocol, to include VOIP (voice over IP).

The access code 120 can be any type of numbers and/or combination of text designators, or any other type of payment authorization, that when entered as the access code 120 on Web site 114, provides access, or continued access, to the Web-based resource 102. In various embodiments of collect callback for Web-based access, an access code provider 128 may be a telecom device, a person, and/or any other type of automated device that can respond to a request for an access code to a Web-based resource. Additionally, in an alternate embodiment, access code provider 128 may be an integrated component of the switch 106.

In an alternate embodiment, the switch 106 receives the callback data from the Web-based resource 102 when a computer user at call source 104 selects the collect callback option, and access to the Web-based resource 102 is pending access authorization. The switch 106 utilizes the call source identifier to initiate and establish a collect call between the call source 104 (e.g., the computer user at telephone 110) and the switch 106 via just the telephone-based communication link 126A. In this example, acceptance of the collect call by the call source establishes that the computer user at call source 104 can be charged on the call source's phone bill for access to the Web-based resource, and the switch 106 notifies the Web-based resource 102 directly that the call source is authorized access such that the Web-based resource 102 can allow the pending call source access to the Web-based resource.

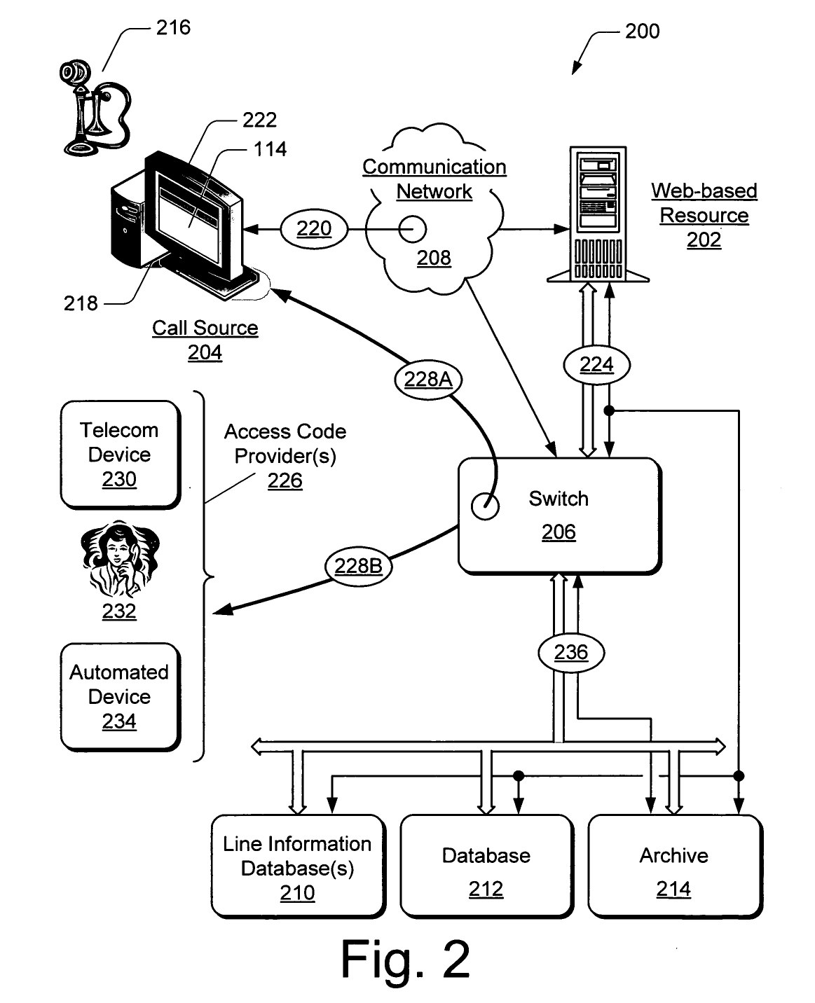

FIG. 2 illustrates an exemplary collect callback system 200 in which an embodiment of collect callback for Web-based access can be implemented. The collect callback system 200 includes a Web-based resource 202, a call source 204, and a switch 206, each of which are configured for communication via a communication network 208, and each of which are described above with reference to similar components shown in FIG. 1. The collect callback system 200 may also be implemented in any form of telecommunications, communications, and/or information services system to include an Internet-based communication system. Collect callback system 200 also includes Line Information Database(s) 210, a database 212, and an archive 214.

In this example, the call source 204 may be a caller (e.g., a person or computer user), a communication device 216 (e.g., a telephone, either wired or wireless), an automated device, any other type of electronic or computing device 218, and/or any combination thereof at a call origin, call station, call location, etc. The call source 204 and the Web-based resource 202 are communicatively coupled, or connected, via communication link 220 through the communication network 208 which can include digital, universal serial bus (USB), local area network (LAN), wide area network (WAN), metropolitan area network (MAN), any form of an Internet Protocol (IP) connection, and other similar types of information and communication connections. The Web-based resource 202 provides a collect callback option via which a computer user at call source 204 can obtain an access code to continue the on-line access after a time duration (e.g., units of minutes or days) during which the call source 204 may or may not be charged for access to the Web-based resource 202.

In one embodiment, such as described with reference to FIG. 1, the computer user can initiate the collect callback option via a Web site associated with the Web-based resource 202. For example, computing device 218 includes a Web browser application to facilitate user interaction with a Web site 114 that is associated with the Web-based resource 202 and which can be displayed on display device 222 of computing device 218. In an alternate embodiment, the Web-based resource 202 may provide the collect callback option to obtain an access code via any type of electronic and/or computing device. When a computer user at call source 204 authorizes a collect call as a form of payment to continue or to gain access to the Web-based resource 202, the Web-based resource 202 communicates callback data to the switch 206 via any type of communication link 224.

Switch 206 and/or the Web-based resource 202 can query the Line Information Database(s) 210 to verify that the call source 204 can be billed for a collect call before establishing the collect call between the call source 204 and an access code provider 226. The Line Information Database 210 is also commonly referred to as “LIDB” and contains call source information, such as a service profile, name and address, and telephone number validation information. The line information is typically accessed by other service providers to determine how to respond to a call or call request. For example, a service provider (e.g., switch 206) can determine whether to allow call source 204 the collect call, or to block the call.

The callback data communicated from Web-based resource 202 to switch 206 includes a Web-based resource identifier (e.g., any type of number and/or text designator) and a call source identifier (e.g., a ten-digit telephone number corresponding to the call source 204). The switch 206 can utilize the call source identifier to initiate and establish a collect call via a telephone-based communication link 228(A-B) between the call source 204 (e.g., the computer user at telephone 216) and the access code provider 226 that provides an access code to the computer user. In this example, the collect call communication link 228 is routed through the switch 206, and acceptance of the collect call by the call source establishes that the computer user at call source 204 can be charged on the call source's phone bill for the Web-based resource access code and/or for the on-line access time.

The access code can be any type of numbers and/or combination of text designators, or other type of payment authorization that provides access, or continued access, to the Web-based resource 202. In various embodiments of collect callback for Web-based access, the access code provider 226 can be a telecom device 230, a person 232 (e.g., an operator), and/or any other type of automated device 234 that can respond to a request for an access code to a Web-based resource. Additionally, in an alternate embodiment, access code provider 226 may be an integrated component of the switch 206.

The database 212 maintains a table or any other form of a data structure of relational data that includes Web-based resource identifiers and associated access code(s) for a particular Web-based resource 202. In an event that a collect callback system is implemented with one or more switches and multiple Web-based resources, a switch 206 can obtain an access code for a particular Web-based resource so that the switch can establish a call source's communication link to the appropriate access code provider 226.

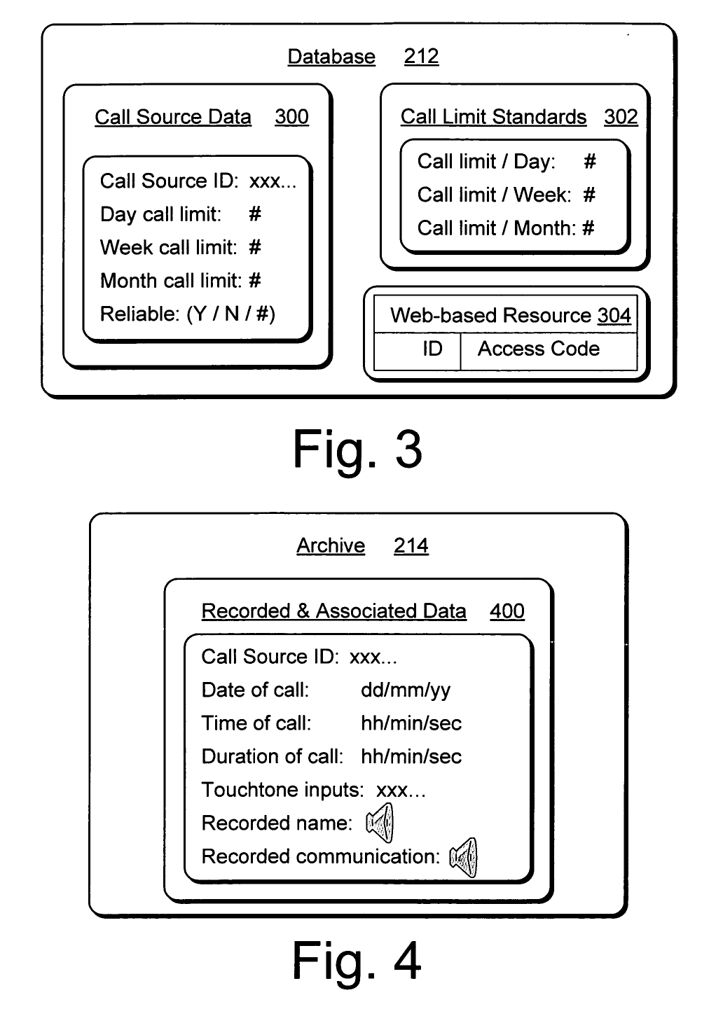

The switch 206 can obtain an access code that corresponds to a Web-based resource identifier received as callback data, and utilize the call source identifier to establish the collect call via the telephone-based communication link 228 between the call source 204 and the access code provider 226. The switch 206 and/or the Web-based resource 202 can also obtain call source data from database 212 that corresponds to the call source 204 to determine whether to authorize the collect call for the call source 204. For example, the call source data includes call limits for the call source which may be compared to call limit standards, also maintained by database 212. The call limits and call limit standards are described further with reference to FIG. 3. The switch 206 and/or the Web-based resource 202 can be communicatively coupled to any of the Line Information Database 210, database 212, and/or archive 214 via any number of different communication links 224 and 236 (e.g., as described with reference to FIG. 1.)

The archive 214 maintains recorded data associated with the collect call. For example, the recorded data can include a recorded name of the call source (e.g., a call source's name) and a recording of the collect call, or a portion of the collect call. Before establishing the collect call communication link 228(A-B), the switch 206 can communicate an instruction (e.g., via communication link 228A) to the call source 204 to verbalize a name to generate the recorded name of the call source.

After verifying and authorizing the collect call, switch 206 can notify the Web-based resource 202 via communication link(s) 224 that the collect call for the call source 204 is authorized. After establishing the collect call communication link 228, the switch 206 can transfer communications, or portions thereof, of the collect call to the archive 214 to generate the recording of the collect call, or a recording of a portion of the collect call.

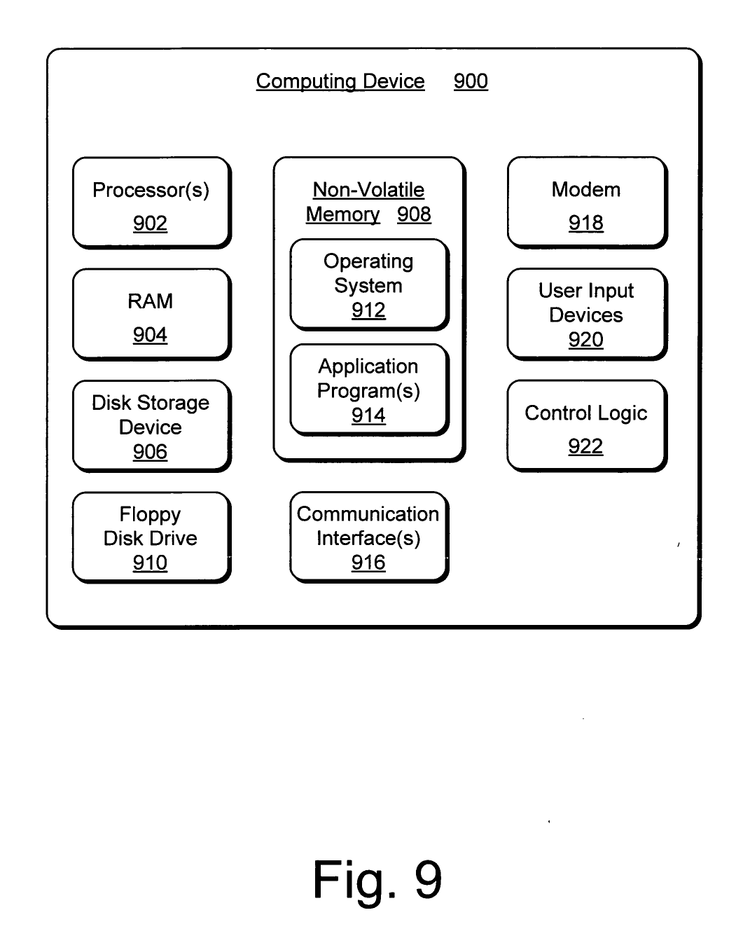

Although database 212 and archive 214 are each illustrated and described as single database implementations, each of the database 212 and the archive 214 can be implemented as several memory components distributed to each maintain data and information pertaining to collect callback in any embodiment of a collect callback system as described herein. Further, although database 212 and archive 214 are each illustrated and described as separate databases, the database 212 and the archive 214 can be implemented together as a single database. Additionally, the database 212 and archive 214 can each be implemented as a memory component of the switch 206. Although not shown in this example, any of the components of a collect callback system (e.g., collect callback systems 100 and 200), such as switch 206, may be implemented with any number and combination of differing components as further described below with reference to the exemplary computing device 900 shown in FIG. 9.

FIG. 3 illustrates examples of data associated with collect callback for Web-based access and maintained with a database 212 as shown in FIG. 2. Call source data 300 corresponds to a call source (e.g., call sources 104 and 204) and can include a call source identifier, a day call limit, a week call limit, month call limit, and/or an indication of whether the call source is reliable in paying for collect call charges in a timely manner. Any and/or all of the call source data 300 can be obtained by a switch 206 and/or Web-based resource 202 to determine whether to authorize a collect call for a particular call source 204.

The database 212 also maintains call limit standards 302 and a table 304 (e.g., any form of a data structure) of relational data that includes a Web-based resource identifier and an associated access code for a particular Web-based resource 202. The call limit standards 302 can be based on established thresholds as determined by uncollected revenue and/or based on the averages of all call sources (e.g., computer users) that do not pay for telephone charges, such as long distance charges, collect call charges, etc. One example of call limit standards 302 can be two calls per day, one call per month, and the like.

The call limits in the call source data 300 for a particular call source 204 can be based on these call limit standards 302, or can be adjusted on a call source by call source basis. For example, the indication of whether a call source is reliable (e.g., “yes”, “no”, and/or some number or text indicator to rate a call source) can be utilized to increase or decrease a particular call source day, week, and month call limits. Optionally, a call source can be blocked from making any calls through the switch due to a poor payment history.

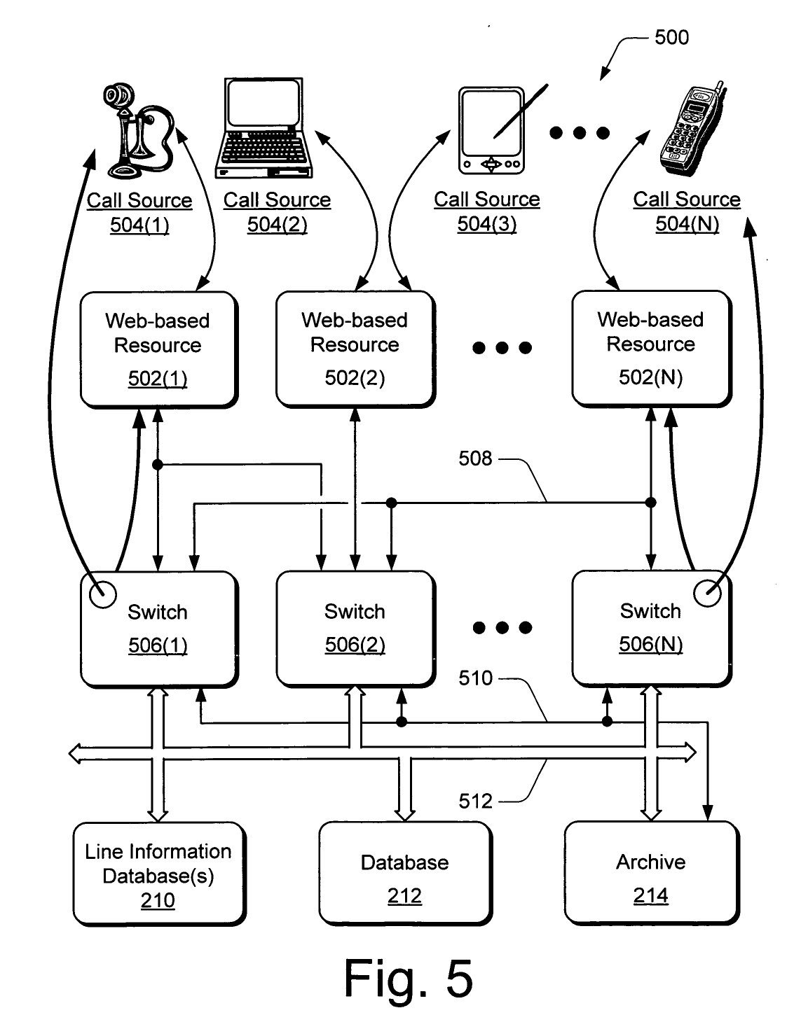

FIG. 4 illustrates an example of recorded and associated data 400 that is maintained in archive 214 and which corresponds to a collect call. The recorded and associated data 400 includes any one or combination of a call source identifier associated with the collect call, a date of the collect call, a time of the collect call, a duration of the collect call, any call source touchtone inputs, a recorded name of a call source, and a recording of the collect call, or a portion thereof.

The switch 206 can obtain any of this archived and recorded information corresponding to a particular collect call when a call source disputes the charges for a collect call. For example, when a caller (e.g., a computer user at a call source 204) calls into a telephone billing company to dispute the charges for a collect call to obtain an access code to access the Web-based resource 202, the caller can be communicatively linked to the recorded and associated data 400 where they will hear themselves identified (e.g., recorded name) and at least a portion of the collect call (e.g., recorded communication). Although database 212 is shown with only one example of call source data 300 for only one call source 204, and archive 214 is shown with only one example of recorded and associated data 400 for a single collect call, each can maintain any number of call source data and recorded data, respectively, that corresponds to any number of call sources and associated collect calls.

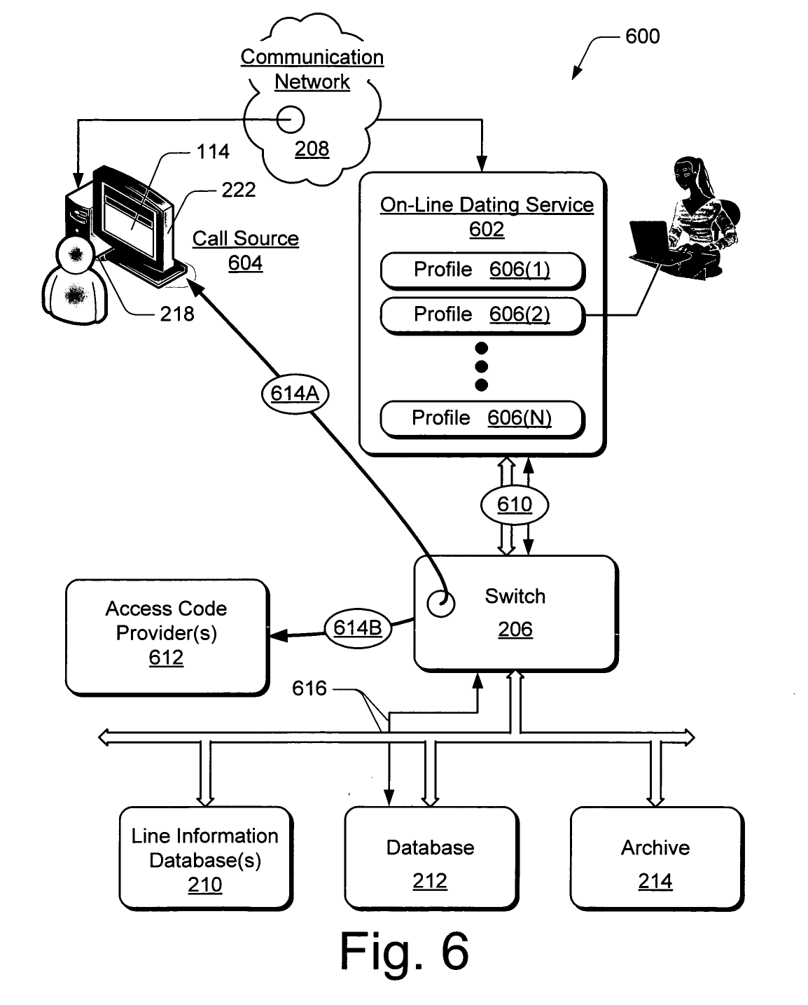

FIG. 5 illustrates an exemplary collect callback system 500 having any number of various components such as multiple Web-based resources 502(1-N), multiple call sources 504(1-N), and multiple switch components 506(1-N). A call source 504 can be any wired or wireless communication device such as any one or combination of a phone 504(1), a portable or desktop computer 504(2), a PDA 504(3), a cell phone 504(N), and/or any other electronic or computing device. Call source 504(2) is an example of a computing device (e.g., call source computing device 112 or call source computing device 218) that can include a Web browser application to facilitate user interaction with a Web site that is associated with a Web-based resource 502, and via which a collect callback option for Web-based access can be initiated by a user of the computer 504(2) at a call source.

Any number of the call sources 504 can be communicatively linked to a Web-based resource 502 at any one time. For example, call sources 504(2) and 504(3) are each in communication with Web-based resource 502(2). Further, any number of the Web-based resources 502 can be communicatively linked to a switch component 506 at any one time via communication links 508. For example, Web-based resources 502(1), 502(2), and 502(N) are all in communication with switch 506(2). Additionally, each switch 506 can access the Line Information Database(s) 210, the database 212, and the archive 214 via communication links 510 and 512.

FIG. 6 illustrates an exemplary implementation of a collect callback system 600 in which an embodiment of collect callback for Web-based access can be implemented. In this example, collect callback system 600 includes an on-line dating service 602 (e.g., a Web-based resource), a call source 604, and the switch 206. Collect callback system 600 also includes Line Information Database(s) 210, the database 212, and the archive 214 as described above with reference to FIGS. 2-4. Additionally, call source 604 is implemented to include computing device 218 which may also include a Web browser application to facilitate user interaction with a Web site 114 that is associated with the on-line dating service 602 and which can be displayed on display device 222 of computing device 218.

The on-line dating service 602 includes multiple profiles 606(1-N) that a computer user at call source 604 can access to view the profiles 606(1-N) via a communication link over communication network 208. In this exemplary implementation, women may access the on-line dating service 602 free of charge and create a profile 606. Men are enticed to access the on-line dating service 602 for a duration of time during which the call source 604 may or may not be charged for the access. The computer user at call source 604 can view the profiles 606 and/or listen to associated recordings and select any of them for a response and to contact the person that created the profile and/or recorded an associated message. Further, if a computer user at call source 604 selects a profile 606 that has been created by someone who is also connected into the on-line dating service 602, the service can connect the computer user at call source 604 and the woman that created the profile 606(2) via instant messaging or another similar communication system.

When the call source's free and/or paid access time has been expended, the on-line dating service 602 can offer the call source 604 a number of payment options to continue the access to the Web-based resource, such as charging the connection time to a credit card, calling a nine-hundred number to which a billing rate applies for a Web site access code, or the on-line dating service 602 can provide a collect callback option via which a computer user at the call source 604 can obtain an access code to continue the on-line access. In one embodiment, the computer user can initiate the collect callback option via a Web site associated with the on-line dating service 602 (e.g., a Web-based resource). For example, computing device 218 can include a Web browser application to facilitate user interaction with a Web site 114 that is associated with the on-line dating service 602 and which can be displayed on display device 222 of computing device 218.

When a computer user at call source 604 authorizes a collect call as a form of payment to continue or to gain access to the on-line dating service 602, the on-line dating service 602 communicates callback data to the switch 206 via any type of communication link 610. Switch 206 and/or the on-line dating service 602 can query the Line Information Database(s) 210 to verify that the call source 604 can be billed for a collect call before establishing the collect call between the call source 604 and an access code provider 612. The callback data received from the on-line dating service 602 includes a dating service identifier (e.g., a Web-based resource identifier and access code 304 shown in FIG. 3) and a call source identifier (e.g., a ten-digit telephone number corresponding to the call source 604).

The switch 206 can utilize the call source identifier to initiate and establish a collect call via a telephone-based communication link 614(A-B) between the call source 604 (e.g., the computer user at a telephone) and the access code provider 612 that provides an access code to the computer user. In this example, the collect call communication link 614 is routed through the switch 206, and acceptance of the collect call by the call source establishes that the computer user at call source 204 can be charged on the call source's phone bill for the on-line dating service access code and/or for the on-line access time. A telephone-based communication link (e.g., communication link 614) can be implemented with any type of telephone communication protocol, to include VOIP (voice over IP).

The switch 206 can obtain an access code that corresponds to the on-line dating service identifier and utilize the call source identifier to establish the collect call via the telephone-based communication link 614 between the call source 604 and the access code provider 612. The switch 206 can also obtain call source data (e.g., call source data 300 shown in FIG. 3) via any type of communication links 616 from database 212 that corresponds to the call source 604 to determine whether to authorize the collect call for the computer user at call source 604. The switch 206 can also communicate an instruction (e.g., via communication link 614A) to the computer user at call source 604 to verbalize a name which is used to generate a recorded name that can be maintained in the archive 214 as recorded data (e.g., recorded and associated data 400 shown in FIG. 4).

After verifying and authorizing the collect call, switch 206 can notify the on-line dating service 602 via communication link(s) 610 that the collect call for the call source 604 is authorized. After establishing the collect call communication link 614, the switch 206 can transfer communications, or portions thereof, of the collect call to the archive 214 to generate a recording of the collect call, or a recording of a portion of the collect call. In an exemplary embodiment, the first sixty seconds of the collect call are recorded.

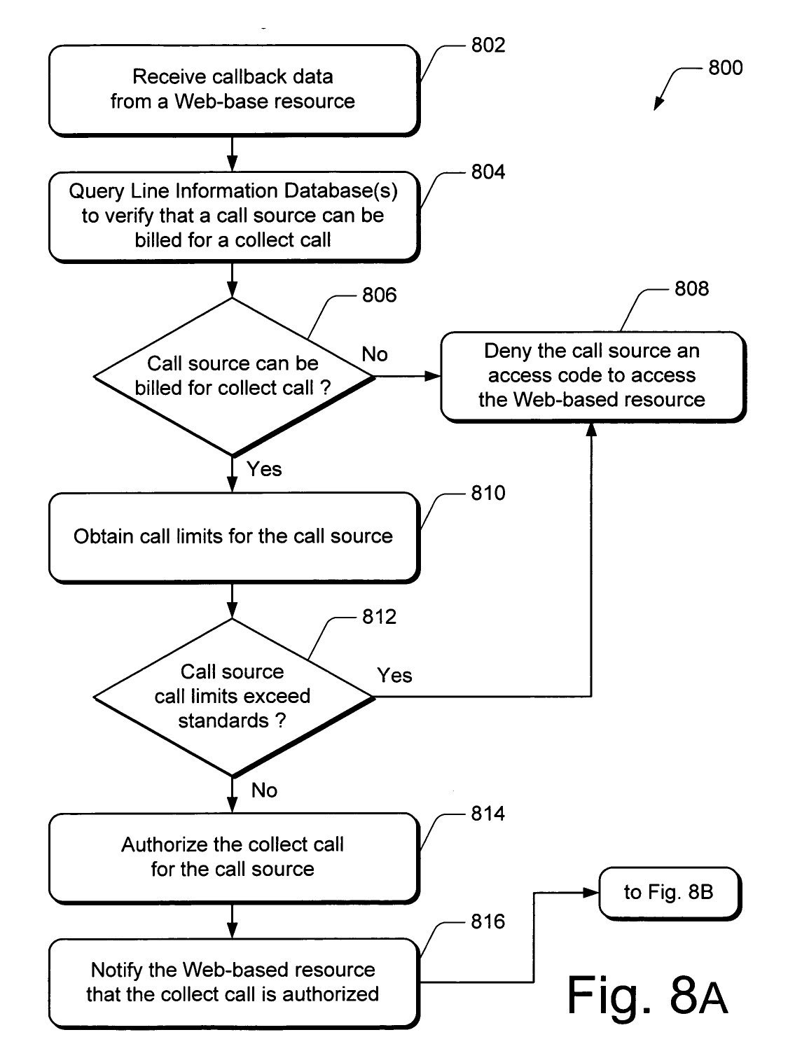

FIG. 7 further illustrates an exemplary implementation 700 of the collect callback system 600 shown in FIG. 6. In this example, a caller 702 (e.g., at a call source 604) receives a phone bill that includes charges for collect call(s) that were authorized to gain access to the Web-based resource 704 (e.g., the on-line dating service 602). The caller 702 calls 706 the billing entity to dispute the charges for the collect call. The billing entity may be the switch 206, the Web-based resource 704, a different billing company 708, and/or any combination thereof which may include a combination of billing entities or companies that cooperate to bill the caller 702 for collect calls. The caller can enter by touch tone or verbally communicate an identifier, or a combination of identifiers, for the collect call to identify the disputed call to the billing entity. For example, the caller may enter by touch tone or verbally communicate a tracking number or a combination of the date and time of the collect call (e.g., identifiers or information included on or with the bill).

The billing entity can then accesses the archive 214 via communication links 710 and 712 through the switch 206 (e.g., or the switch 206 accesses the archive 214 directly if the switch is the billing entity). The switch establishes a playback communication link 714 to the caller 702 and from the recorded data 400 that corresponds to the disputed collect call. The caller 702 will hear his own identification (e.g., recorded name) and a portion of the collect call (e.g., recorded communication). The playback communication link 714 can be routed through the billing entity, such as through the Web-based resource 704 (e.g., the on-line dating service 602) as shown in FIG. 7. The caller's own identification and recorded portion of the collect call is more than sufficient to sustain the charges against the caller 702.

In an alternate implementation, the switch 206 can obtain the recorded data 400 from archive 214 and submit the recorded data to other agencies (or agency) 716 via a communication link 718 through the switch 206. The recorded data can be submitted as an attached audio file to an email, for example. This may be useful for police investigations, legal challenges, and for any other similar situation in which it is desirable to evidence that a particular caller was a party to a communication on a particular date for a recorded duration of time and/or that the caller authorized payment for a call.

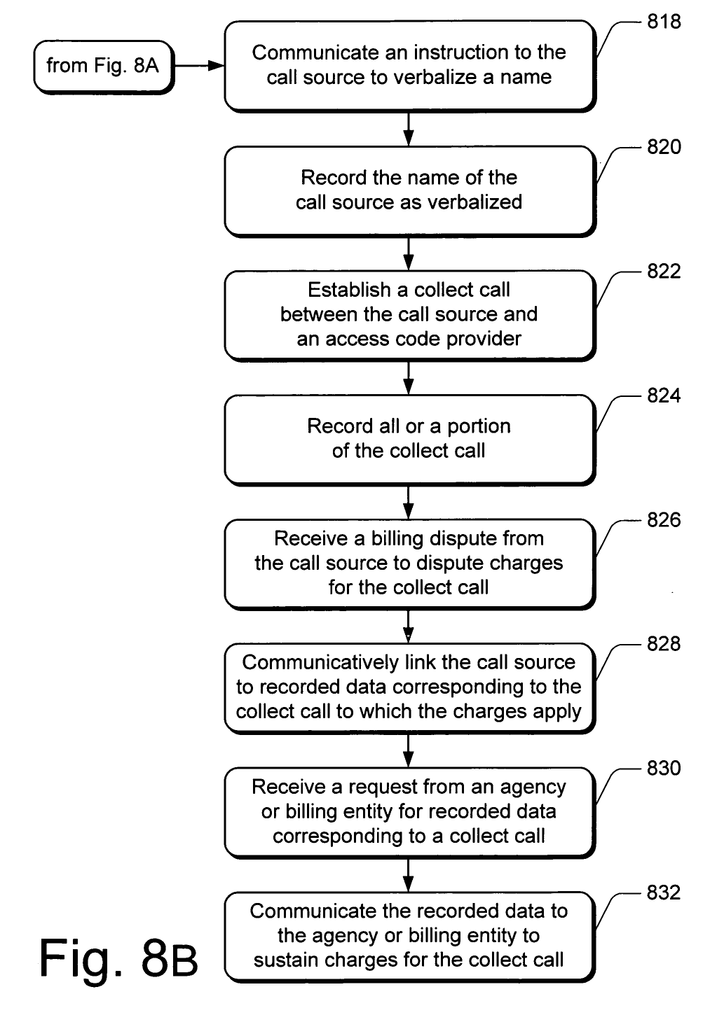

Methods for collect callback for Web-based access, such as exemplary method 800 described with reference to FIGS. 8A and 8B, may be described in the general context of computer-executable instructions. Generally, computer-executable instructions include routines, programs, objects, components, data structures, and the like that perform particular functions or implement particular abstract data types. Methods for collect callback for Web-based access may also be practiced in distributed computing environments where functions are performed by remote processing devices that are linked through a communications network. In a distributed computing environment, computer-executable instructions may be located in both local and remote computer storage media, including memory storage devices.

FIGS. 8A and 8B illustrate a method 800 for collect callback for Web-based access. The order in which the method is described is not intended to be construed as a limitation, and any number of the described method blocks can be combined in any order to implement the method. Furthermore, the method can be implemented in any suitable hardware, software, firmware, or combination thereof.

At block 802 (FIG. 8A), callback data is received from a Web-based resource. The Web-based resource receives a collect callback selection from a call source to which the Web-based resource has initiated a collect callback option. For example, Web-based resource 202 (FIG. 2) provides a collect callback option via which a computer user at call source 204 can obtain an access code to continue on-line access to the Web-based resource 202. The computer user at call source 204 authorizes, or otherwise selects, the collect callback option and the Web-based resource 202 communicates callback data to switch 206. Receiving the callback data includes receiving a call source identifier and a Web-based resource identifier that corresponds to an associated access code for the Web-based resource 202.

At block 804, a Line Information Database is queried to verify that a call source can be billed for a collect call and at block 806, a determination is made as to whether the call source can be billed for the collect call. The switch 206 and/or the Web-based resource 202 can query the Line Information Database 210 to determine whether the call source 204 can be billed for the collect call. If the call source cannot be billed for the collect call (i.e., “no” from block 806), then the call source is denied an access code to access the Web-based resource at block 808. If the call source can be billed for the collect call (i.e., “yes” from block 806), then call limits for the call source are obtained at block 810. For example, switch 206 (FIG. 2) and/or the Web-based resource 202 obtains call limits from the call source data 300 (FIG. 3) maintained with database 212.

At block 812, a determination is made as to whether the call limits for the call source exceed call limit standards. For example, switch 206 compares the call limits 300 for the call source to call limit standards 302 also maintained with database 212. The call limit standards 302 may include, but are not limited to, a day limit, a week limit, and/or a month limit for calls by a particular call source. If the call limits for the call source do exceed call limit standards (i.e., “yes” from block 812), then the call source is again denied the access code to access the Web-based resource at block 808. If the call limits for the call source do not exceed call limit standards (i.e., “no” from block 812), then the collect call is authorized for the call source at block 814.

At block 816, the Web-based resource is notified that the collect call for the call source is authorized. For example, the switch 206 notifies the Web-based resource 202 that the collect call for a computer user at call source 204 is authorized. At block 818 (FIG. 8B), an instruction is communicated to the call source to verbalize a name. For example, switch 206 communicates an instruction via communication link 228A to the call source 204 to verbalize a name to be recorded. At block 820, the name of the call source is recorded as verbalized. For example, the recorded name of the computer user at call source 204 is maintained with the recorded and associated data 400 in archive 214 (FIG. 4).

At block 822, the collect call is established via a telephone-based communication link between the call source and an access code provider. For example, the switch 206 establishes the collect call via communication link 228 between call source 204 and an access code provider 226 through the switch 206. A Web-based resource access code is then provided to the computer user at call source 204 so that the computer user may access or continue to access the Web-based resource 202. At block 824, all or a portion of the collect call is recorded. For example, a recording of the collect call is maintained with the recorded and associated data 400 in archive 214 (FIG. 4). The recorded and associated data 400 maintained with archive 214 also includes at least one of a call source identifier, a date of the collect call, a time of the collect call, a duration of the collect call, and/or call source touchtone inputs.

At block 826, a billing dispute is received from the call source to dispute charges for the collect call pertaining to the Web-based resource access. For example, a caller 702 (FIG. 7) calls a billing entity (e.g., switch 206, Web-based resource 704, or billing company 708) to dispute the charges for a collect call initiated to gain access to the on-line dating service 602. At block 828, the call source is communicatively linked to an archive of recorded data corresponding to the collect call to which the charges apply. For example, switch 206 establishes a communication link 714 (FIG. 7) between the archive 214 and caller 702 (e.g., the call source) such that the caller can listen to the recorded data 400 which includes the caller's recorded name and a recording of a portion of the collect call.

At block 830, a request is received from an agency or billing entity for recorded data corresponding to the collect call. The recorded data can include the recorded name of the call source and the recording of the portion of the collect call. For example, an agency 716 (FIG. 7) can request the recorded data 400 from switch 206. At block 832, the recorded data is communicated to the agency or billing entity such that the agency or billing entity can utilize the recorded data to sustain charges for a collect call. For example, switch 206 communicates the recorded data 400 to an agency 716 via communication link 718.

FIG. 9 illustrates an exemplary computing device 900 that may be implemented as any one of the various components of a collect callback system in which collect callback for Web-based access is implemented, such as a switch (e.g., switches 106, 206, and 506), a database 212 and archive 214, a Web-based resource (e.g., Web-based resources 102, 202, 502, 602, and 704), and as a call source (e.g., call sources 104, 204, 504, and 604). Computing device 900 includes one or more processors 902 (e.g., any of microprocessors, controllers, and the like) which process various instructions to control the operation of computing device 900 and to communicate with other electronic and computing devices. Computing device 900 can be implemented with one or more memory components, examples of which include a random access memory (RAM) 904, a disk storage device 906, non-volatile memory 908 (e.g., any one or more of a read-only memory (ROM), flash memory, EPROM, EEPROM, etc.), and a floppy disk drive 910.

Disk storage device 906 can include any type of magnetic or optical storage device, such as a hard disk drive, a magnetic tape, a recordable and/or rewriteable compact disc (CD), a DVD, DVD+RW, and the like. The one or more memory components provide data storage mechanisms to store various information and/or data such as configuration information for computing device 900, and any other types of information and data related to operational aspects of computing device 900. Alternative implementations of computing device 900 can include a range of processing and memory capabilities, and may include any number of differing memory components than those illustrated in FIG. 9.

An operating system 912 and one or more application program(s) 914 can be stored in non-volatile memory 908 and executed on processor(s) 902 to provide a runtime environment for computing device 900. An application program 914 can include a Web browser application to facilitate user interaction with a Web-based resource via the Internet. Computing device 900 further includes one or more communication interfaces 916 and a modem 918. The communication interfaces 916 can be implemented as any one or more of a serial and/or parallel interface, as a wireless interface, any type of network interface, and as any other type of communication interface. A wireless interface enables computing device 900 to receive control input commands and other information from an input device, such as from a remote control device or from another infrared (IR), 802.11, Bluetooth, or similar RF input device.

A network interface provides a connection between computing device 900 and a data communication network which allows other electronic and computing devices coupled to a common data communication network to communicate information to computing device 900 via the network. Similarly, a serial and/or parallel interface provides a data communication path directly between computing device 900 and another electronic or computing device. Modem 918 facilitates computing device 900 communications with other electronic and computing devices via a conventional telephone line, a DSL connection, cable, and/or via other types of connections.

Computing device 900 may include user input devices 920 that can include a keyboard, mouse, pointing device, and/or other mechanisms to interact with, and to input information to computing device 900. Computing device 900 also may include control logic 922. As used herein, the term “logic” refers to hardware, firmware, software, or any combination thereof that may be implemented to perform the logical operations associated with a particular function or with the operability of computing device 900, a switch (e.g., switch 206), a database (e.g., database 212 and archive 214), or a call source (e.g., computing device 218). Logic may also include any supporting circuitry that is utilized to complete a given task including supportive non-logical operations. For example, logic may also include analog circuitry, memory components, input/output (I/O) circuitry, interface circuitry, power providing/regulating circuitry, and the like.

Although shown separately, some of the components of computing device 900 may be implemented in an application specific integrated circuit (ASIC). Additionally, a system bus (not shown) typically connects the various components within computing device 900. A system bus can be implemented as one or more of any of several types of bus structures, including a memory bus or memory controller, a peripheral bus, an accelerated graphics port, or a local bus using any of a variety of bus architectures.

Although collect callback for Web-based access has been described in language specific to structural features and/or methods, it is to be understood that the subject of the appended claims is not necessarily limited to the specific features or methods described. Rather, the specific features and methods are disclosed as exemplary implementations of collect callback for Web-based access.

1. A collect callback system, comprising:
a Web-based resource configured to provide a collect callback option via which a call source can obtain an access code to access the Web-based resource; and
a switch configured to receive callback data from the Web-based resource, the switch further configured to establish a collect call via a telephone-based communication link between the call source and an access code provider that provides the access code to the call source.

2. A collect callback system as recited in claim 1, wherein the switch is further configured to route the collect call between the call source and the access code provider through the switch.

3. A collect callback system as recited in claim 1, wherein the Web-based resource is further configured to provide the collect callback option via a Web site associated with the Web-based resource.

4. A collect callback system as recited in claim 1, wherein the Web-based resource is implemented as a component of the switch.

5. A collect callback system as recited in claim 1, wherein the switch is further configured to notify the Web-based resource that the collect call for the call source is authorized.

6. A collect callback system as recited in claim 1, wherein the switch is further configured to query a Line Information Database to verify that the call source can be billed for the collect call.

7. A collect callback system as recited in claim 1, further comprising a database configured to maintain call source data that corresponds to the call source, and wherein the switch is further configured to obtain the call source data from the database and authorize the collect call for the call source.

8. A collect callback system as recited in claim 1, further comprising a database configured to maintain a Web-based resource identifier, and wherein the switch is further configured to:
receive the callback data which includes the Web-based resource identifier and a call source identifier; and
utilize the call source identifier to establish the collect call via the telephone-based communication link between the call source and the access code provider.

9. A collect callback system as recited in claim 1, further comprising a database configured to:
maintain call source data that corresponds to the call source, the call source data including call limits for the call source;
maintain call limit standards that identify at least one of a day limit, a week limit, or a month limit; and
wherein the switch is further configured to obtain the call source data from the database and authorize the collect call for the call source if the call limits for the call source do not exceed the call limit standards.

10. A collect callback system as recited in claim 1, further comprising a database configured to maintain an archive of recorded data associated with the collect call between the call source and the access code provider, the recorded data including a recorded name of the call source and a recording of at least a portion of the collect call;
wherein the switch is further configured to:
communicate an instruction to the call source to verbalize a name to generate the recorded name of the call source; and
transfer at least a portion of the collect call to the database to generate the recording of the collect call.

11. A collect callback system as recited in claim 1, further comprising a database configured to maintain an archive of recorded data associated with the collect call between the call source and the access code provider, the recorded data including at least one of a call source identifier, a date of the collect call, a time of the collect call, a duration of the collect call, call source touchtone inputs, a recorded name of the call source, or a recording of at least a portion of the collect call;
wherein the switch is further configured to:
communicate an instruction to the call source to verbalize a name to generate the recorded name of the call source; and
transfer at least a portion of the collect call to the database to generate the recording of the collect call.

12. A collect callback system as recited in claim 1, further comprising a database configured to:
maintain call source data that corresponds to the call source, the call source data including call limits for the call source;
maintain call limit standards that identify at least one of a day limit, a week limit, or a month limit;
maintain an archive of recorded data associated with the collect call between the call source and the access code provider, the recorded data including a recorded name of the call source and a recording of at least a portion of the collect call;
wherein the switch is further configured to:
query a Line Information Database to verify that the call source can be billed for the collect call;
obtain the call source data from the database and authorize the collect call for the call source if the call limits for the call source do not exceed the call limit standards;
communicate an instruction to the call source to verbalize a name to generate the recorded name of the call source; and
transfer at least a portion of the collect call to the database to generate the recording of the collect call.

13. An Internet-based system comprising the collect callback system as recited in claim 1.

14. A collect callback system, comprising:
a switch configured to receive callback data from a Web-based resource that provides a collect callback option via which a call source can obtain an access code to access the Web-based resource;
a database configured to maintain an archive of recorded data associated with a collect call between the call source and an access code provider, the recorded data including a recorded name of the call source and a recording of at least a portion of the collect call;
the switch further configured to:
establish the collect call via a telephone-based communication link between the call source and the access code provider;
communicate an instruction to the call source to verbalize a name to generate the recorded name of the call source; and
transfer at least the portion of the collect call to the database to generate the recording of the collect call.

15. A collect callback system as recited in claim 14, wherein the Web-based resource and the database are implemented as components of the switch.

16. A collect callback system as recited in claim 14, wherein the switch is further configured to route the collect call between the call source and the access code provider through the switch.

17. A collect callback system as recited in claim 14, wherein the database is further configured to maintain associated recorded data that includes at least one of a call source identifier, a date of the collect call, a time of the collect call, a duration of the collect call, or call source touchtone inputs.

18. A collect callback system as recited in claim 14, wherein the switch is further configured to notify the Web-based resource that the collect call for the call source is authorized.

19. A collect callback system as recited in claim 14, wherein the switch is further configured to query a Line Information Database to verify that the call source can be billed for the collect call.

20. A collect callback system as recited in claim 14, wherein the database is further configured to maintain call source data that corresponds to the call source, and wherein the switch is further configured to obtain the call source data from the database and authorize the collect call for the call source.

21. A collect callback system as recited in claim 14, wherein the database is further configured to maintain a Web-based resource identifier, and wherein the switch is further configured to:
receive the callback data which includes the Web-based resource identifier and a call source identifier; and
utilize the call source identifier to establish the collect call via the telephone-based communication link between the call source and the access code provider.

22. A collect callback system as recited in claim 14, wherein the database is further configured to:
maintain call source data that corresponds to the call source, the call source data including call limits for the call source;
maintain call limit standards that identify at least one of a day limit, a week limit, or a month limit; and
wherein the switch is further configured to obtain the call source data from the database and authorize the collect call for the call source if the call limits for the call source do not exceed the call limit standards.

23. An Internet-based system comprising the collect callback system as recited in claim 14.

24. A collect callback system comprising a Web-based resource configured to:
establish an Internet-based communication link with a call source;
provide a collect callback option via which the call source can obtain an access code to access the Web-based resource;
receive an authorization input for collect call payment from the call source;
communicate callback data to a switch that initiates a collect call between the call source and an access code provider via a telephone-based communication link that is routed through the switch; and
receive the access code from the call source via the Internet-based communication link.

25. A collect callback system comprising a switch configured to:
receive callback data that includes a Web-based resource identifier and a call source identifier from a Web-based resource that provides a collect callback option via which a call source can obtain an access code to access the Web-based resource;
utilize the call source identifier to initiate a collect call via a telephone-based communication link between the call source and an access code provider;
communicate an instruction to the call source to verbalize a name to generate a recorded name of the call source; and
generate a recording of at least a portion of the collect call.

26. A collect callback system comprising a billing entity configured to:
receive a billing dispute from a caller that disputes charges for a collect call to access a Web-based resource that provided a collect callback option via which the caller authorized the collect call to obtain an access code to access the Web-based resource; and
communicatively link the caller to an archive of recorded data corresponding to the collect call to which the charges apply, the recorded data including a recording of at least a portion of the collect call and further including a recorded name of the caller verbalized by the caller.

27. A collect callback system, comprising:
a Web-based resource configured to (1) establish an Internet-based communication link with a call source, (2) provide a collect callback option via which a call source can obtain an access code to access the Web-based resource and (3) receive an authorization input for the collect call from the call source;
a database configured to maintain an archive of recorded data associated with the collect call, the recorded data including a recorded name of the caller and a recording of at least a portion of the collect call;
a switch configured to (1) receive callback data from the Web-based resource, (2) establish the collect call via a telephone-based communication link between the call source and an access code provider, (3) communicate an instruction to the call source to verbalize a name to generate the recorded name, and (4) transfer the collect call to the database to generate the recording of the at least a portion of the collect call.

28. A collect callback system as recited in claim 27, wherein the switch is further configured to route the collect call via the telephone-based communication link through the switch.

29. A collect callback system as recited in claim 27, wherein the database is further configured to maintain associated recorded data that includes at least one of a caller identifier, a date of the collect call, a time of the collect call, a duration of the collect call, or caller touchtone inputs.

30. A collect callback system as recited in claim 27, wherein the switch is further configured to notify the Web-based resource that the collect call for the call source is authorized.

31. A collect callback system as recited in claim 27, wherein the database is further configured to maintain call source data that corresponds to the call source, and wherein the switch is further configured to:
query a Line Information Database to verify that the call source can be billed for the collect call;
obtain the call source data from the database; and
authorize the collect call for the call source.

32. A collect callback system as recited in claim 27, wherein the database is further configured to maintain a Web-based resource identifier, and wherein the switch is further configured to:
receive the callback data which includes the Web-based resource identifier and a call source identifier; and
utilize the call source identifier to establish the collect call via the telephone-based communication link between the call source and access code provider.

33. A collect callback system as recited in claim 27, wherein the database is further configured to:
maintain call source data that corresponds to the call source, the call source data including call limits for the call source;
maintain call limit standards that identify at least one of a day limit, a week limit, or a month limit; and
wherein the switch is further configured to obtain the call source data from the database and authorize the collect call for the call source if the call limits for the call source do not exceed the call limit standards.

34. A collect callback system as recited in claim 27, further comprising a billing entity configured to:
bill the call source for the collect call;
receive a billing dispute from the call source that disputes charges for the collect call to obtain access to the Web-based resource;
communicatively link the call source to the archive of recorded data associated with the collect call to which the charges apply; and
playback the recorded name of the call source and the recording of the collect call to the call source such that the charges for the collect call can be sustained.

35. An Internet-based system comprising the collect callback system as recited in claim 27.

36. A method for collect callback, comprising:
receiving callback data from a Web-based resource that receives a collect callback authorization from a call source to which the Web-based resource has provided a collect callback option to obtain an access code to access the Web-based resource;
establishing a collect call via a telephone-based communication link between the call source and an access code provider;
communicating an instruction to the call source to verbalize a name;
recording the name of the call source; and
recording at least a portion of the collect call.

37. A method for collect callback as recited in claim 36, further comprising providing the call source with the access code to access the Web-based resource.

38. A method for collect callback as recited in claim 36, further comprising maintaining recorded data that includes at least one of the recording of the call source name, the recording of the portion of the collect call, a call source identifier, a date of the collect call, a time of the collect call, a duration of the collect call, or call source touchtone inputs.

39. A method for collect callback as recited in claim 36, further comprising notifying the Web-based resource that the collect call for the call source is authorized.

40. A method for collect callback as recited in claim 36, further comprising querying a Line Information Database to verify that the call source can be billed for the collect call.

41. A method for collect callback as recited in claim 36, wherein receiving the callback data includes receiving a call source identifier and a Web-based resource identifier that corresponds to the access code for the Web-based resource.

42. A method for collect callback as recited in claim 36, further comprising:
obtaining call limits for the call source; and
authorizing the collect call for the call source if the call limits for the call source do not exceed call limit standards that identify at least one of a day limit, a week limit, or a month limit.

43. A method for collect callback as recited in claim 36, further comprising:
receiving a billing dispute from the call source that disputes charges for the collect call to obtain the access code; and
communicatively linking the call source to an archive of recorded data corresponding to the collect call to which the charges apply, the recorded data including the recording of the call source name and the recording of the portion of the collect call.

44. A method for collect callback as recited in claim 36, further comprising:
receiving a request from a billing entity for recorded data corresponding to the collect call, the recorded data including the recording of the call source name and the recording of the portion of the collect call; and
communicating the recorded data to the billing entity such that the billing entity can utilize the recorded data to sustain the charges for the collect call.

45. A method for collect callback, comprising:
providing a collect callback option for a call source as a form of payment to obtain an access code;
receiving authorization for a collect call from the call source; and
establishing a telephone-based communication link as the collect call between the call source and an access code provider that provides the access code.

46. A method for collect callback as recited in claim 45, further comprising communicating callback data to a switch that utilizes the callback data to establish the collect call as the telephone-based communication link through the switch.

47. A method for collect callback, comprising:
establishing an Internet-based communication link between a call source and a Web-based resource;
initiating a collect callback option for the call source as a form of payment to obtain an access code for access to the Web-based resource;
receiving an authorization input for the collect call from the call source;
establishing the collect call via a telephone-based communication link between the call source and an access code provider;
maintaining an archive of recorded data associated with the collect call, the recorded data including a recording of at least a portion of the collect call; and
recording the portion of the collect call.

48. A method for collect as recited in claim 47, further comprising communicating an instruction to the call source to verbalize a name to generate a recorded name of the call source that is maintained in the archive as a additional recorded data associated with the collect call.

49. A method for collect callback as recited in claim 47, further comprising maintaining associated recorded data that includes at least one of a caller identifier, a date of the collect call, a time of the collect call, a duration of the collect call, or caller touchtone inputs.

50. A method for collect callback as recited in claim 47, further comprising notifying the Web-based resource that the collect call for the call source is authorized.

51. A method for collect callback as recited in claim 47, further comprising querying a Line Information Database to verify that the call source can be billed for the collect call.

52. A method for collect callback as recited in claim 47, further comprising:
maintaining call source data that corresponds to the call source, the call source data including call limits for the call source;
maintaining call limit standards that identify at least one of a day limit, a week limit, or a month limit; and
authorizing the collect call for the call source if the call limits for the call source do not exceed the call limit standards.

53. A method for collect callback as recited in claim 47, comprising:
receiving a billing dispute from the call source to dispute charges for the collect call to obtain access to the Web-based resource;
communicatively linking the call source to the archive of recorded data associated with the collect call to which the charges apply; and
playing back the recorded name of the call source and the recording of the portion of the collect call to the call source such that the charges for the collect call can be sustained.

54. One or more computer-readable media comprising computer executable instructions that, when executed, direct a telecommunications switch to:
receive callback data from a Web-based resource that receives a collect callback selection from a call source;
establish a collect call between the call source and an access code provider, the collect call established as a communication link through the switch;
communicate an instruction to the call source to verbalize a name;
record the name of the call source; and
record at least a portion of the collect call.

55. One or more computer-readable media as recited in claim 54, further comprising computer executable instructions that, when executed, direct the telecommunications switch to notify the Web-based resource that the collect call for the call source is authorized.

56. One or more computer-readable media as recited in claim 54, further comprising computer executable instructions that, when executed, direct the telecommunications switch to query a Line Information Database to verify that the call source can be billed for the collect call.

57. One or more computer-readable media as recited in claim 54, further comprising computer executable instructions that, when executed, direct the telecommunications switch to:
obtain call limits for the call source; and
authorize the collect call for the call source if the call limits for the call source do not exceed call limit standards that identify at least one of a day limit, a week limit, or a month limit.

58. A collect callback system, comprising a Web-based resource configured to:
establish an Internet-based communication link with a call source to provide a collect callback option via which the call source can obtain an access code to access the Web-based resource;
receive an authorization input for collect call payment from the call source; and
establish a collect call via a telephone-based communication link between the call source and an access code provider that provides the access code.

59. A collect callback system as recited in claim 58, wherein the Web-based resource is further configured to query a Line Information Database to verify that the call source can be billed for the collect call.

60. A collect callback system as recited in claim 58, wherein the Web-based resource is an integrated component of a telecommunications switch.

61. A collect callback system as recited in claim 58, wherein the Web-based resource is further configured to obtain call source data from a database and authorize the collect call for the call source.

62. A collect callback system as recited in claim 58, wherein the Web-based resource is further configured to record the authorization input for the collect call payment.

63. A collect callback system, comprising:
a Web-based resource configured to provide a collect callback option via which a call source can authorize payment to access the Web-based resource; and
a switch configured to:
receive callback data from the Web-based resource;
establish a collect call with the call source via a telephone-based communication link;
receive a payment authorization from the call source via the collect call; and
notify the Web-based resource that the call source is authorized such that the Web-based resource can allow the call source access to the Web-based resource.

64. A collect callback system as recited in claim 63, wherein the Web-based resource is further configured to provide the collect callback option via a Web site associated with the Web-based resource.

65. A collect callback system as recited in claim 63, wherein the Web-based resource is implemented as a component of the switch.

66. A collect callback system as recited in claim 63, wherein the switch is further configured to query a Line Information Database to verify that the call source can be billed for the collect call.

67. A collect callback system as recited in claim 63, further comprising a database configured to maintain call source data that corresponds to the call source, and wherein the switch is further configured to obtain the call source data from the database and authorize the collect call for the call source.

68. A collect callback system as recited in claim 63, further comprising a database configured to maintain an archive of recorded data associated with the collect call, the recorded data including a recorded name of the call source and a recording of at least a portion of the collect call;
wherein the switch is further configured to:
communicate an instruction to the call source to verbalize a name to generate the recorded name of the call source; and
transfer at least a portion of the collect call to the database to generate the recording of the collect call.

69. A method, comprising:
providing a collect callback option via which a call source can authorize payment to access a Web-based resource;
receiving callback data from the Web-based resource;
establishing a collect call with the call source via a telephone-based communication link;
receiving a payment authorization from the call source via the collect call; and
notifying the Web-based resource that the call source is authorized such that the Web-based resource can allow the call source access to the Web-based resource.

70. A collect callback system as recited in claim 69, wherein providing the collect callback option includes providing the collect callback option via a Web site associated with the Web-based resource.

71. A collect callback system as recited in claim 69, further comprising querying a Line Information Database to verify that the call source can be billed for the collect call.

72. A collect callback system as recited in claim 69, further comprising maintaining call source data that corresponds to the call source, obtaining the call source data from the database, and authorizing the collect call for the call source.
